(19) United States
(12) Patent Application Publication
(10) Pub. No.: US 2015/0063461 A1
(43) Pub. Date: Mar. 5, 2015

(54) METHODS AND APPARATUSES FOR ADJUSTING MACROBLOCK QUANTIZATION PARAMETERS TO IMPROVE VISUAL QUALITY FOR LOSSY VIDEO ENCODING

(71) Applicant: Magnum Semiconductor, Inc., Milpitas, CA (US)

(72) Inventor: Dong Zheng, Ottawa (CA)

(73) Assignee: Magnum Semiconductor, Inc., Milpitas, CA (US)

(21) Appl. No.: 14/011,535

(22) Filed: Aug. 27, 2013

(51) Int. Cl. H04N 19/14; H04N 19/176; H04N 19/18; H04N 19/124

(52) U.S. Cl. CPC H04N 19/00157; H04N 19/0009; H04N 19/00278; H04N 19/00296
USPC 375/240.24

(57) ABSTRACT

A method of encoding is provided. The method includes generating transform coefficients corresponding to macroblocks of video data, at least in part using a transform unit. The method also includes calculating a visual quality importance index for each of the macroblocks, wherein the visual quality importance index reflects a relative importance of the respective macroblock to subjective image quality. The method further includes receiving initial quantization parameters for the macroblocks from a rate control unit; dynamically adjusting the quantization parameters based, at least in part, on the visual quality importance index; and quantizing the transform coefficients using the dynamically adjusted quantization parameters.

### TECHNICAL FIELD

Examples described herein relate to video encoding. Examples include methods and apparatuses for adjusting macroblock quantization parameters for different regions in a video frame or video image which may improve visual quality for lossy video encoding.

### BACKGROUND

Digitization of a video image, video signal, or video frame may include sampling on a discrete grid or pixels. Each pixel may be assigned a number of bits. Once the video image is converted into bits, processing may be performed, including video image enhancement, video image restoration, and video image compression.

A macroblock typically includes 16×16 samples, and may be further divided into transform blocks. A video image may be transformed to produce a set of blocks of transform coefficients to achieve lossy compression. For example, the video image may be divided into discrete macroblocks (e.g. 16 by 16 pixels in the case of MPEG). These macroblocks may be subjected to discrete cosine transform (DCT) to calculate frequency components, both vertically and horizontally, in a matrix. The transform coefficients in the DCT matrix are then quantized.

Quantization is a lossy compression technique achieved by compressing a range of values to a single quantum value. Quantization may include color quantization, which reduces the number of colors used in an image. Quantization may also include frequency quantization, which reduces the information associated with high frequency components, as a human eye is not sensitive to rapid brightness variation. As a result of frequency quantization, high frequency components may be rounded to zero.

During quantization, the transform coefficients in the DCT matrix are then divided by a standard quantization matrix and rounded to an integer value. As a result of quantization, the transform coefficients are more coarsely represented at lower bit rates, and more transform coefficients are zero. The loss of information through the quantization process may make compression lossy—e.g. some information has been lost through quantization. Statistically, images may have more low frequency components or content than high frequency components or content. For example, low frequency components may remain after quantization, which may result in blurry or low-resolution blocks.

### BRIEF DESCRIPTION OF THE DRAWINGS

FIG. 1 illustrates a video encoder system in accordance with embodiments of the present disclosure.

FIG. 2 illustrates a video encoder system in accordance with embodiments of the present disclosure.

FIG. 3 is a flow chart illustrating an example of video encoding in accordance with embodiments of the present disclosure.

FIG. 4 is a diagram illustrating a calculation of visual quality importance index of

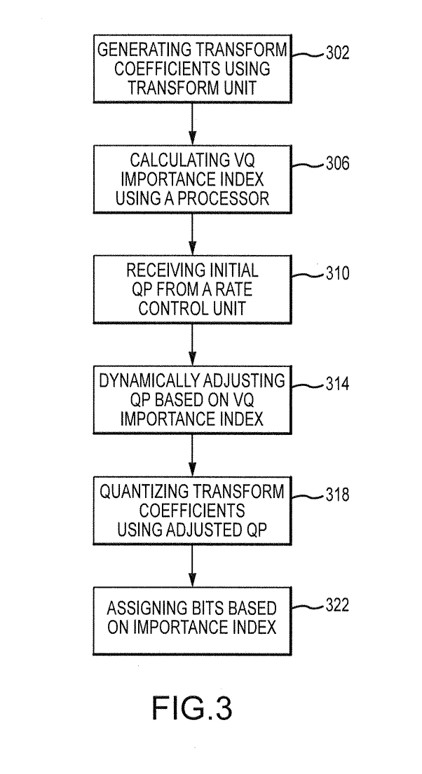

FIG. 3 in accordance with embodiments of the present disclosure.

FIG. 5 is a flow chart illustrating an example of dynamically adjusting quantization parameters of FIG. 3.

FIG. 6 is a simplified diagram illustrating various regions with different visual important indexes and corresponding bit spending in accordance with embodiments of the present disclosure.

FIG. 7A shows an example video frame.

FIG. 7B shows an example visual quality importance index map for the video frame of FIG. 7A in accordance with embodiments of the present disclosure.

FIG. 8A shows another example video frame.

FIG. 8B shows an example visual quality importance index map for the video frame of FIG. 8A in accordance with embodiments of the present disclosure.

FIG. 9 is a schematic illustration of a media delivery system in accordance with embodiments of the present disclosure.

### DETAILED DESCRIPTION

Certain details are set forth below to provide a sufficient understanding of embodiments of the disclosure. However, it will be clear to one having skill in the art that embodiments of the disclosure may be practiced without these particular details, or with additional or different details. Moreover, the particular embodiments described herein are provided by way of example and should not be used to limit the scope of the disclosure to these particular embodiments. In other instances, well-known video components, encoder or decoder components, circuits, control signals, timing protocols, and software operations have not been shown in detail in order to avoid unnecessarily obscuring the disclosure.

Examples of methods and apparatuses are described herein that adjust macroblock quantization parameters in a manner which may improve subjective visual quality of a resulting encoded image. To simulate how a viewer may see a video image, a visual quality (VQ) importance index is calculated based upon the content of the video image. The VQ importance index is assigned to portions of a video image, e.g. frames, macroblocks, pixels, or other coding units based on the importance of the portion of the video image to subjective perception by a human viewer. Subjective video quality generally reflects how human viewers evaluate the video quality. Thus, the VQ importance index may help guide the quantization process to determine how best to distribute the encoding bits. For example, more bits may be used to encode portions of a video image which will have a greater importance to subjective video quality and fewer bits may be used to encode portions of a video image which will have lesser importance to subjective video quality.

Different regions of a video image or video frame or macroblocks of video data have different visual importance indexes to human viewers. Then, at least one quantization parameter, such as a quantization step, may be adjusted for different portions of a video image based on the characteristic of video contents and the VQ importance index. The adjusted quantization parameters (e.g. quantization step) may control the output of the bitstream. For example, a smaller quantization step value may lead to more bits generated from an entropy encoder, while a larger quantization step value may lead to less bits generated from the entropy encoder.

By identifying and classifying the regions with different visual quality importance indexes, the encoding bits spent for the video image or video frame may be adjusted to enhance the subjective visual quality for regions with higher VQ importance index by using more bits for encoding. The bit spending may be adjusted by changing the quantization parameters of macroblocks. Generally, the macroblocks with high VQ importance index may be assigned smaller quantization parameters, such that more bits would be used to encode those macroblocks. While macroblocks with low VQ importance index may be encoded with larger quantization parameters and thus fewer bits would be used for encoding these macroblocks.

The VQ importance index may be calculated per macroblock, or other coding unit, based on statistics information associated with each macroblock including, but not limited to, spatial activity of the macroblock which indicates content complexity of the macroblock, luminance contrast index of the macroblock, edge information, and skintone color information. The spatial activity generally refers to the summation of horizontal pixel absolute difference and vertical pixel absolute difference in a macroblock.

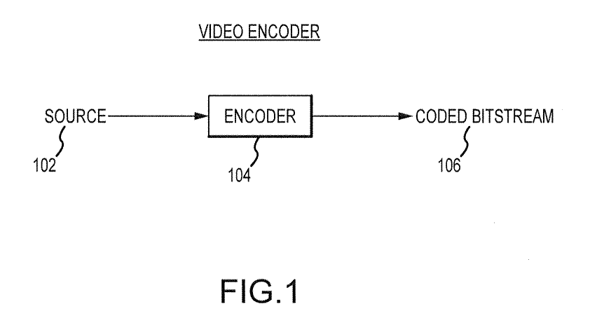

FIG. 1 illustrates a video encoder system in accordance with embodiments of the present disclosure. As shown, a source 102 provides a video signal to a video encoder 104. The video signal may include data representing one or more video images. The encoder 104 receives the video signal and outputs an encoded bitstream 106 at a reduced bitrate. The encoded bitstream 106 may be compliant with one or more standards including, but not limited to, MPEG or H.264. The video encoder 104 may be implemented in hardware, software, firmware, or combinations thereof. The video encoder 104 may include control logic, logic gates, processors, memory, and/or any combination or sub-combination of the same, and may be configured to encode and/or compress a video signal to produce a coded bitstream signal using one or more encoding techniques. The video encoder 104 may be implemented in any of a variety of devices employing video encoding, including, but not limited to, televisions, broadcast systems, mobile devices, and both laptop and desktop computers. Macroblocks, or other coding units, of a video signal may be encoded in intra-coded mode, inter-coded mode, bidirectionally, or in any combination or subcombination of the same.

As an example, the encoder 104 may receive and encode a video signal that may include video data (which may be arranged, e.g., in frames). The video signal may be encoded in accordance with one or more encoding standards, such as but not limited to MPEG-2, MPEG-4, H.263, H.264, and/or HEVC, to provide the encoded bitstream, which may be provided to a data bus and/or to a device, such as a decoder or transcoder (not shown).

Encoder 104 may produce constant bitrate (CBR) or variable bitrate (VBR) bitstreams. As content complexity of source 104, the bitrates of the encoded bitstreams may vary over time. A quantification of content complexity is often specific to a video coding methodology and the encoder used to encode the content.

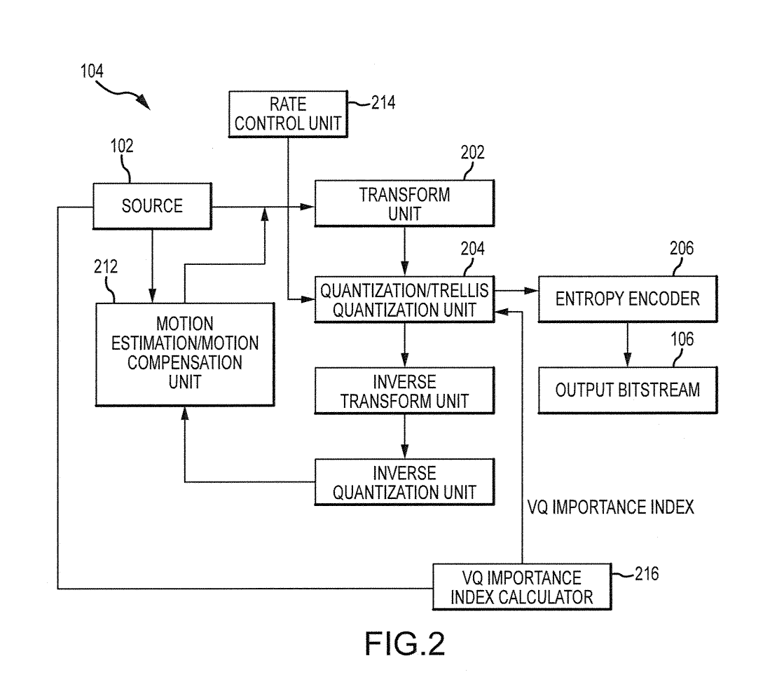

FIG. 2 illustrates a video encoder system in accordance with embodiments of the present disclosure. Video encoder 104 may include a transform unit 202 coupled to a quantization unit 204 which is coupled to an entropy encoder 206. The transform unit 202 generates transform coefficients corresponding to macroblocks, or other coding units, of video data for a video image. The quantization unit 204 controls output bitrate by adjusting the quantization parameter based on the VQ importance index. The entropy encoder 206 generates encoded bitstream 106. The video encoder 104 may also include a motion estimation/compensation unit 212, which may help reduce the spatial and temporal redundancy of the input contents. The video encoder 104 may further include a rate control unit 214 coupled to the quantization unit 204. The rate control unit 214 provides initial frame level quantization parameters to the quantization unit 204.

The video encoder 104 may also include a feedback loop that includes inverse transform unit 208 and inverse quantization unit 210. The inverse transform unit 208 and inverse quantization unit 210 may provide a reconstructed video image which may approximate the video image as decoded in a decoder. The reconstructed video image may be provided to the motion estimation/motion compensation unit 212 or another unit for comparison with the source image. In this manner, a residual may be obtained which may be used to improve the encoding process.

The transform unit 202 may be configured to perform a transform, such as a discrete cosine transform (DCT), on the signal received from the source 102 to produce a set of blocks of transform coefficients (typically in blocks of 8×8 pixels or 4×4 pixels) that may, for instance, correspond to spectral components of the video signal. Generally, the transform unit 202 may transform the video signal to a frequency domain representation. Although DCT is described here, other transform techniques may be used. When the DCT is used, the coefficients of the DCT matrix are typically scanned using a zig-zag scan order. The output of the transform unit 202, the block of transform coefficients, is then quantized by the quantization unit 204.

The quantization unit 204 may be configured to receive the transform coefficients and quantize the transform coefficients to produce quantized transform coefficients. The quantization parameters used to perform the quantization and generate the quantized transform coefficients may be adjusted based on the calculated VQ importance index and initial frame level quantization parameters for a macroblock in the quantization unit 204. Furthermore, trellis quantization may in some examples further fine tune the quantization process by tracing through the quantization of all pixels within the macroblock. Then, entropy encoding is applied to the quantized transform coefficients by the entropy encoder 206. Entropy coding typically combines a number of consecutive zero-valued quantized coefficients with the next non-zero quantized coefficient into a single symbol, and also indicates when all of the remaining quantized coefficient values are equal to zero.

The entropy encoder 206 may encode the quantized transform coefficients with an encoding technique, such as context-adaptive variable length coding (CAVLC). The entropy encoder 206 may receive syntax elements (e.g., quantized transform coefficients, differential motion vectors, macroblock modes, etc.) from other components of the encoder, such as directly from the quantization unit 204 and indirectly from the motion estimation/compensation block 212. The entropy encoder 206 may be a variable length coding encoder (e.g., Huffman encoder, CAVLC encoder, or context-adaptive binary arithmetic coding (CABAC) encoder), which may be configured to encode data, for instance, at a macroblock level.

The entropy encoder 206 controls the output of an encoded bitstream. The bit spending for different portions of a video image may be controlled by adjusting the quantization parameters (e.g. quantization step value) based on the VQ importance index. Entropy encoding is a data compression scheme that is independent of the specific characteristics of the medium. The entropy encoding typically uses variable-length coding tables. The entropy coding may create and assign a unique prefix-free code to each unique symbol that occurs in the input. The entropy encoding then may compress data by replacing each fixed-length input symbol with a variable-length prefix-free output code word, such that the macroblocks, or other coding units, with higher VQ importance index may use a larger number of bits.

In some embodiments, the encoder 104 may operate in accordance with the MPEG-2 video coding standard, the H.264 video coding standard, or other standards. Thus, because the MPEG-2 and the H.264 video coding standards employ motion prediction and/or compensation, the encoder 104 may further include a feedback loop that includes an inverse transform unit 208 and an inverse quantization unit 210. These elements may mirror elements included in a decoder (not shown) that is configured to reverse, at least in part, the encoding process performed by the encoder 104. Additionally, the feedback loop of the encoder 104 may include a motion estimation/compensation block 212.

The inverse transform unit 208 may inversely transform the quantized transform coefficients for a macroblock to produce reconstructed transform coefficients. The inverse quantization unit 210 may inversely quantize the reconstructed transform coefficients to provide recovered transform coefficients.

The motion estimation/compensation block 212 receives the recovered transform coefficients for use in macroblock intra-mode prediction and/or inter-mode prediction mode decision methodologies. Modem block based video coding standards such as MPEG2, H.261, H.262, H.263 and H.264 may take advantage of temporal and spatial redundancy to achieve efficient video compression. An intra-coded block or macroblock is coded based on predictions from neighboring macroblocks, whereas inter-coded macroblocks are coded based on temporal predictions. Video frames are typically organized using intra-frames (I-frames), containing all intra-coded macroblocks, with a series of inter-coded frames (P-frames) in between. P-frames cannot be properly decoded without first decoding one or more previous frames. I-frames are generally larger than P-frames, but are required for random access (e.g., a receiver capable of entering a video stream at any point, and to limit the propagation of transmission errors.

Some spatial and temporal downsampling may also be used to reduce raw data rate from source 102 before encoding which starts from transform unit 202. As shown in FIG. 2, the motion estimation/compensation block 212 may receive data from source 102 and compress the raw data and provide the data to the transform unit 202. The motion estimation/compensation unit 212 may reduce the spatial and temporal redundancy of the input contents. As shown in FIG. 2, a VQ important index calculator 216 is connected to source 102 to receive a video image signal and also connected to the quantization block 204 to output calculated VQ importance index. The VQ important index calculator 216 calculates the VQ importance indexes for different portions of the video image, and provide the calculated VQ importance indexes to the quantization unit 204. The VQ importance index calculator may be implemented using one or more processors, logic gates, or other circuitry. In some examples, the VQ importance index calculator may be implemented using software and one or more computing systems programmed to perform examples of the VQ importance index calculation described herein.

FIG. 3 is a flow chart illustrating an example of video encoding in accordance with embodiments of the present disclosure. Method 300 includes generating transform coefficients corresponding to macroblocks of video data in the transform unit 202 at 302. While the method is described with reference to macroblocks, other coding units may be used in other examples. Method 300 may continue with calculating visual quality (VQ) importance index at 306. In some examples, the VQ important index calculator 216 may be used to calculate the visual quality importance index. In other examples, other circuitry or software may be used.

The method 300 may also include receiving initial quantization parameters for the macroblocks from a rate control unit at 310 and dynamically adjusting quantization parameters based on the calculated VQ importance index in the quantization unit 204 at 314. The adjustment to the quantization parameters may vary with the video data over time, for example, dynamically.

Method 300 may also include quantizing the transform coefficients using the dynamically adjusted quantization parameters in the quantization unit 204 at 318. In a particular embodiment, a quantization scheme in video encoding may be represented by the following equation:

$$F = floor ( \frac{f}{Δ} ) sign ( f )$$

where F is a quantized transform coefficient, f is a transform coefficient, and Δ is a quantization step value, which is a quantization parameter. The quantization step value may be adjusted for each macroblock, or other coding unit. By adjusting the quantization step value, the number of bits used by the entropy encoder 206 to encode particular portions of the video signal may be varied.

Method 300 may further include assigning bit spending based on the VQ importance index by the entropy encoder 206 at 322. When the quantization step value is large, more bits may be eliminated during the quantization process, and less bits may be generated for the transform coefficient f in the encoded bitstream output from the entropy encoder. On the other hand, a smaller quantization step value may lead to more bits being preserved for the transform coefficient f, and thus more bits may be used in the output bitstream from the entropy encoder 206 to represent the particular transform coefficient.

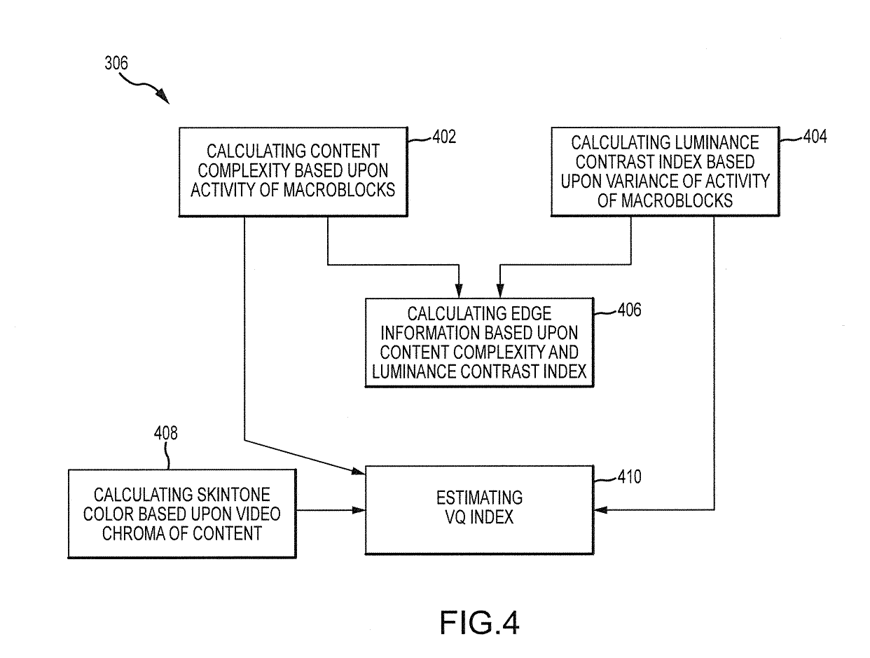

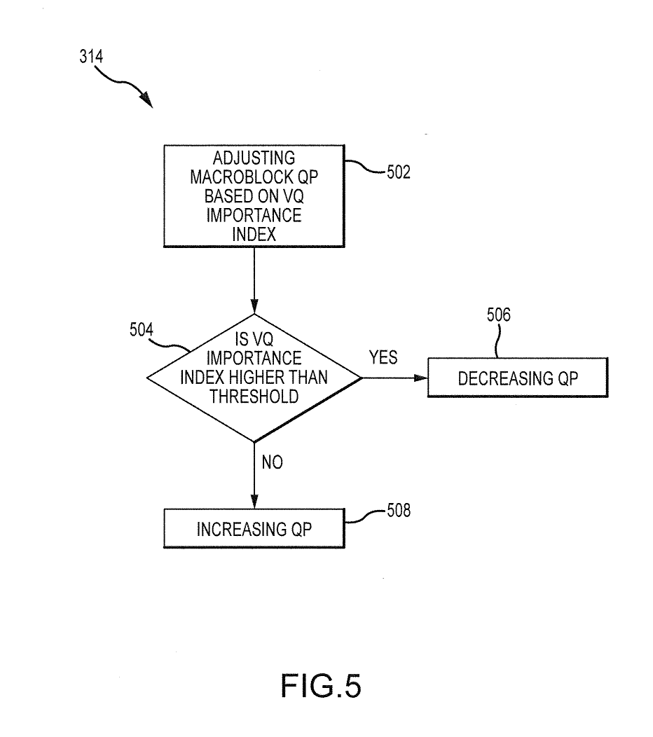

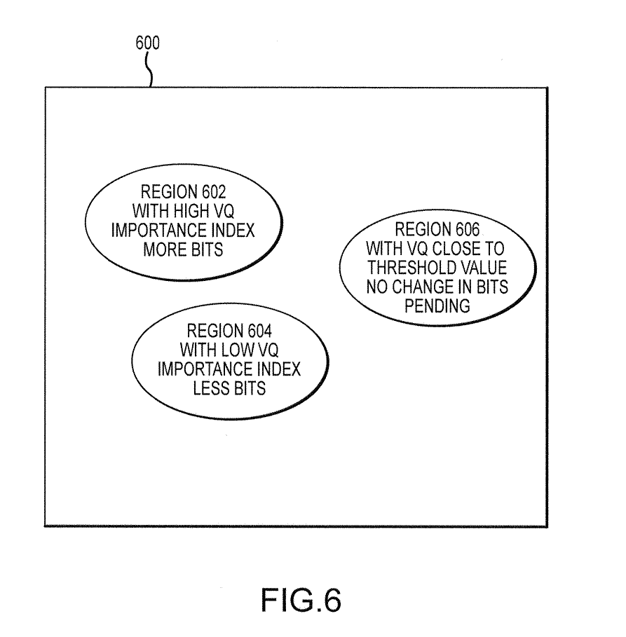

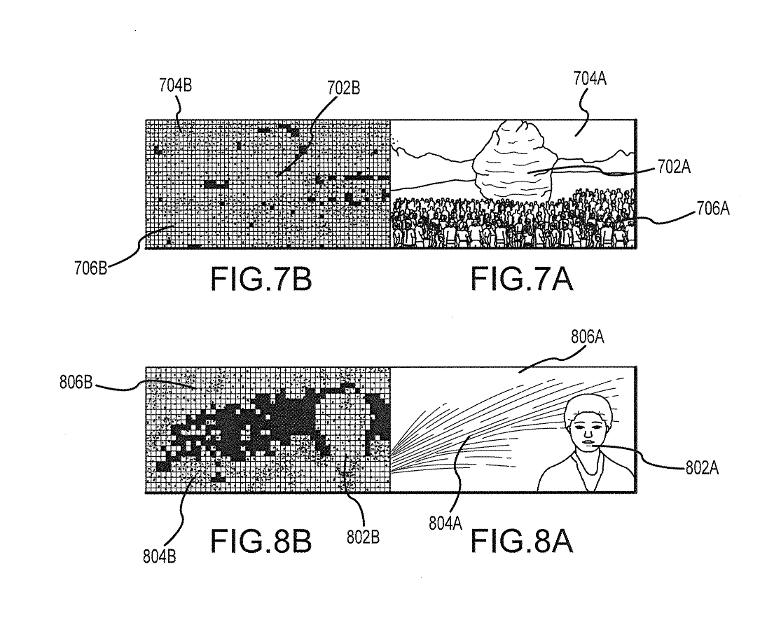

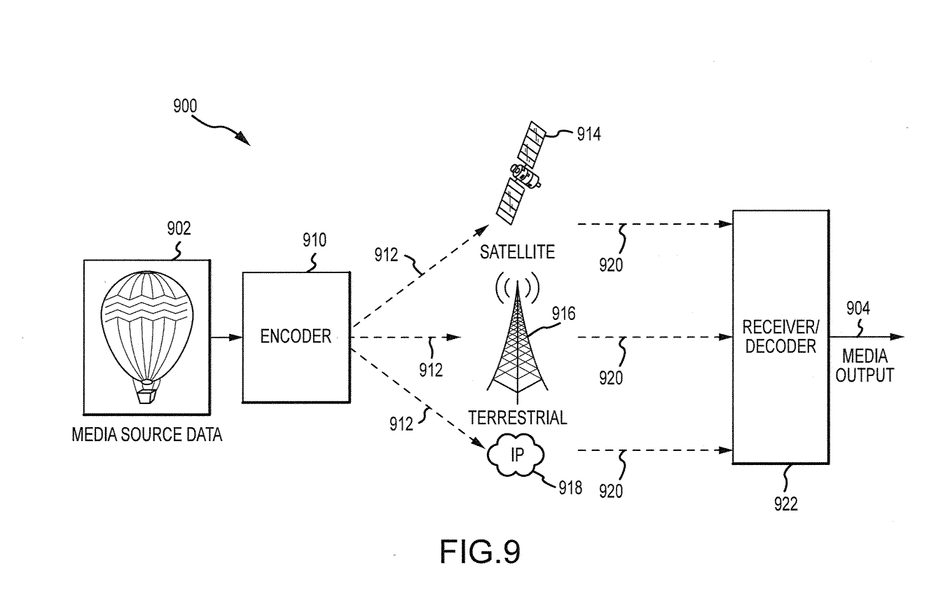

FIG. 4 is a diagram illustrating an example of calculating visual quality importance index of FIG. 3 in accordance with embodiments of the present disclosure. The VQ importance index for each macroblock, or other coding unit, may be calculated by a processor or other circuitry (not shown) by taking several factors into account, such as, but not limited to, content complexity, luminance contrast index, edge information, skintone color information of video data, or combinations thereof at block 410. In some examples, the VQ importance index may be calculated using a computing system programmed with software to perform the calculations described herein.

Content complexity may be calculated, at least in part, based on activity of the macroblock at block 402, where the activity may be given as the summation of horizontal pixel absolute difference and vertical pixel absolute difference in a macroblock. For example, the difference between intensity of horizontally adjacent pixels may be summed for each of the horizontally adjacent pixel pairs in a macroblock. Similarly, the difference between intensity of vertically adjacent pixels may be summed for each of the vertically adjacent pixel pairs in a macroblock. These two sums may also be summed and used as a measure of activity of a macroblock. In other examples, activity may be calculated in other manners. Activity is generally a measure of how much intensity variation is present across the coding unit.

Luminance contrast index may be calculated, at least in part, based on variance of the activity of the macroblock at block 404. First, the variance of a macroblock may be calculated based on the difference between the pixel values and the macroblock pixel average value. For example, the difference between the intensity of each pixel and an average intensity for the coding unit, e.g. macroblock, may be calculated and the differences summed for all pixels in the macroblock. This sum may represent a variance of the macroblock. Then, the ratio between the activity and the variance may be calculated as the luminance contrast index.

Edge information may be identified at block 406, at least in part, based on the luminance contrast index obtained from block 404 and the content complexity obtained at block 402. Edge information may be important to human viewers, where the human eye is sensitive to the appearance of edges. Visual quality of the image may be improved by identifying edge boundaries and providing more bits to improve the sharpness of the edge. For example, if the content complexity of a macroblock exceeds a threshold while the luminance contrast index is less than a threshold value, the portion of the video image may be flagged as having edge information. In one example, the threshold value for content complexity may be 1000 and the threshold value for luminance contrast index may be 10. Such that if both conditions (Content complexity>1000) and (Luminance contrast index<10) are met in one example, the associated portion of the video image, e.g. macroblock, is flagged as containing edge information.

Skintone color information may be calculated, at least in part, using the chroma information of the video content at block 408. Skintone color information may include human skin color information, which may vary with, for example but not limited to, race and sun tanning, including dark skin or light skin. Skintone color information may also include object color information, which may have various colors. Skintone color information is important to human viewers, which helps clearly distinguish different people or objects. Accordingly, chroma information may be compared with stored values or ranges of values that may correspond with skintone coloration. Stored chroma values indicative of skintone coloration, which may include ranges of values, may be stored in any suitable electronic storage medium accessible to the VQ importance index calculator. In block 408, the chroma information of a video signal may be compared with the stored chroma values indicative of skintone coloration and coding units, e.g. macroblocks, having chroma values indicative of skintone information may be flagged as containing skintone information.

In general, macroblocks with more content complexity, edge information, or skintone color information tend to have higher VQ importance index, while macroblocks with higher luminance contrast index tend to have lower VQ importance index. In a particular embodiment, the value of VQ importance index may vary from 1 to 5 with a step size of 1. The larger value of VQ importance index indicates that the macroblock is more important to human viewers in terms of subjective visual quality. While content complexity, luminance content index, edge information, and skintone color have been described herein as factors used to calculate a VQ importance index, it is to be understood that any combination or sub-combination of these factors may be used in embodiments of the present invention. Other factors may be used in combination with or instead of these factors in other embodiments.

Once the VQ importance index is calculated, the quantization parameter (QP) of each macroblock may be adjusted from an initial quantization parameter (e.g. initial_QP) from a rate control unit using the calculated VQ importance index. First, a frame level QP may be determined by a rate control process or received from the rate control unit 214. Then, the quantization parameter may be adjusted.

FIG. 5 is a flow chart illustrating an example of dynamically adjusting quantization parameters, as recited in FIG. 3. At block 502, adjusting quantization parameters may include adjusting quantization parameters, at least in part, based on the VQ importance index. Block 314 may also include comparing the VQ importance index to a threshold value at block 504. If the VQ importance index is higher than the threshold value, block 314 may include decreasing the quantization parameter at block 506. If the VQ importance index is lower than the threshold value, block 314 may include increasing the quantization parameter at block 508. If the VQ important index is the same as the threshold value, no adjustment in the quantization parameters may be made in some examples.

The macroblock quantization parameter may also be adaptively adjusted based on the following rules. Generally, the following rules are applied to macroblock quantization parameter adjustment. In one embodiment, if a macroblock has high activity and low VQ importance index (such as 1 or 2), the macroblock quantization parameter is increased to initial_QP+1. In another embodiment, if a macroblock has middle activity and high VQ importance index (such as 4 or 5), the macroblock quantization parameter is decreased to initial_QP−1. In a further embodiment, if a macroblock has low activity and high VQ importance index, the macroblock quantization parameter is decreased to initial_QP−2.

More specifically, for regions with relatively high VQ importance index (such as 4 or 5 in a particular embodiment), QP may be reduced from an initial QP during the quantization and/or trellis quantization. For example, for regions with skintone color information or edge information, the quantization parameter may be decreased, including decreasing the QP by 2 to frame level_QP−2. Additionally or instead, for portions of the image meeting the condition that both luminance contrast index is greater than a threshold (e.g. 15) and content complexity lies within a predetermined range (e.g. from at least 4000 to 6000), the quantization parameter may be decreased, e.g. decreased by 1 to frame level_QP−1 in some examples. Furthermore, for portions of a video image meeting the condition that both luminance contrast index is greater than a threshold (e.g. 10) and content complexity lies within a predetermined range (e.g. between at least 2000 and 4000), the quantization parameter may be decreased, e.g. decreased by 1 to frame level_QP−1.

On the other hand, for portions of a video image with a lower VQ importance index (such as 1 or 2), the macroblock quantization parameter may be increased during the quantization and/or trellis quantization. For example, for regions meeting the condition that both luminance contrast index is smaller than a threshold (e.g. 20) and content complexity is greater than a threshold (e.g. 10000), the quantization parameter may be increased, e.g. increased by 1 to frame level_QP+1. Additionally or instead, for regions meeting the condition that both luminance contrast index is smaller than a threshold (e.g. 15) and content complexity lies within a predetermined range (e.g. between at least 8000 and 10000), the quantization parameter may be increased, e.g. increased by 1 to frame level_QP+1.

For portions of a video image with a middle range of VQ importance index (such as 3 which may be a threshold value), the quantization parameter may remain unchanged as initial frame level_QP.

FIG. 6 is a diagram illustrating various portions of a video image with different visual importance indexes and corresponding bit spending in accordance with embodiments of the present disclosure. Region 602 has a higher VQ importance index than a threshold value, which may indicate that its encoding quality is more important to human viewers than region 604 which has a smaller VQ importance index than the threshold value. Thus, when a bit budget for the video frame is provided, the subjective video quality may be improved by using more bits to encode the region 602 with higher VQ importance index and less bits to encode the region 604 with smaller VQ importance index. Region 606 may have a VQ importance index close to the threshold value, and there are no changes in assigned bits from original bits.

FIG. 7A shows an example video frame. Image 700A shows a crowd of humans running on grass with clouds in the background. The crowd mostly surrounds a tree. FIG. 7B shows one example VQ importance index map for the video frame (e.g. image) shown in FIG. 7A in accordance with embodiments of the present disclosure. As shown in FIG. 7B, the VQ importance index 700B includes bright regions 702B, dark regions 704B, and intermediate regions 706B. The bright regions 702B have a higher VQ importance index than the dark regions. For example, a bright region 702B as shown in FIG. 7B is associated with a first corresponding tree region 702A as shown in FIG. 7A. The tree region 702A has a higher VQ index that is associated with the content complexity of the tree region 702B. The dark region 704B as shown in FIG. 7B is associated with a corresponding brighter cloud region 704A as shown in FIG. 7A. The cloud region 704A is bright and has less content complexity, and thus has a lower VQ importance index and is less important to human viewers. The intermediate region 706B as shown in FIG. 7B includes bright blocks mixed with dark blocks. The intermediate region 706B corresponds to the human crowd 706A running near the tree region 702A as shown in FIG. 7A. The human crowd 706A includes men and women, old and young wearing clothes of different colors including red, blue, black, yellow, and white, which has certain content complexity or variation. The VQ importance index for the crowd region 706A may be intermediate and is between that of tree region 702A and that of the cloud region 704A.

In a particular embodiment, there may be 5 grayscale levels in the VQ importance index map shown in FIG. 7B, which corresponds with the VQ importance index from 1 to 5. With this scale, tree region 702A may have VQ importance index of 4 or 5, while cloud region 704A may have VQ importance index of 1 or 2, and crowd region 706A may have VQ importance index of 3.

FIG. 8A shows another example video frame. Video frame 800A includes a human face region, water spray toward the human, and a greenish background. FIG. 8B shows another example VQ importance index map for a video frame shown in FIG. 8A in accordance with embodiments of the present disclosure. As shown in FIG. 8B, VQ importance index map 800B includes a bright region 802B, which corresponds to a human face region 802A as shown in FIG. 8A. This human face region 802A has a higher VQ importance index due to the content complexity, skintone, edge of the face, and may therefore be more important in terms of subjective visual quality. VQ importance index map 800B also includes a dark region 804B, which corresponds to water spray region 804A as shown in FIG. 8A. The water spray region 804A is bright, and may therefore have a lower VQ importance index. The water spray region 804A is less important in terms of subjective visual quality. VQ importance index map 800B further includes an intermediate region 806B with a combination of gray blocks and bright blocks, which corresponds to green background region 806A in FIG. 8A. The green background region 806A may have an intermediate VQ importance index, which is between that of the human face region 802A and that of the water spray region 804A.

In a particular embodiment, there may be 5 grayscale levels in the VQ importance index map shown in FIG. 8B, which corresponds with the VQ importance index from 1 to 5. With this scale, human face region 802A may have VQ importance index of 4 or 5, while water spray region 804A may have VQ importance index of 1 or 2, and background region 806A may have VQ importance index of 3.

FIG. 9 is a schematic illustration of a media delivery system in accordance with embodiments of the present disclosure. Media delivery system 900 may provide a mechanism for delivering media source 902 data to one or more of a variety of media output(s) 904. Although only one media source 902 and media output 904 are illustrated in FIG. 9, it is to be understood that any number of media sources or media outputs may be used, and examples may be used to broadcast and/or otherwise deliver media content to any number of media outputs.

The media source data 902 may be any source of media content, including but not limited to, video, audio, data, or combinations thereof. The media source data 902 may be, for example, audio and/or video data that may be captured using a camera, microphone, and/or other capturing devices, or may be generated or provided by a processing device. Media source data 902 may be analog or digital. When the media source data 902 is analog data, the media source data 902 may be converted to digital data using, for example, an analog-to-digital converter (ADC). Typically, to transmit the media source data 902, some type of compression and/or encryption may be desirable. Accordingly, an encoder 910 which may employ the VQ importance index calculation and bit assignment techniques described herein may be provided that may encode the media source data 902 using any encoding method in the art, known now or in the future, including encoding methods in accordance with video standards such as, but not limited to, MPEG-2, MPEG-4, H.264, HEVC, or combinations of these or other encoding standards. The encoder 910 may be implemented using any encoder according to an embodiment of the invention, including the encoder 104, and further may be used to implement the method 300 of FIG. 3.

The encoded data 912 may be provided to a communications link, such as a satellite 914, an antenna 916, and/or a network 918. The network 918 may be wired or wireless, and further may communicate using electrical and/or optical transmission. The antenna 916 may be a terrestrial antenna, and may, for example, receive and transmit conventional AM and FM signals, satellite signals, or other signals known in the art. The communications link may broadcast the encoded data 912, and in some examples may alter the encoded data 912 and broadcast the altered encoded data 912 (e.g., by re-encoding, adding to, or subtracting from the encoded data 912). The encoded data 920 provided from the communications link may be received by a receiver 922 that may include or be coupled to a decoder. The decoder may decode the encoded data 920 to provide one or more media outputs, with the media output 904 shown in FIG. 9.

The receiver 922 may be included in or in communication with any number of devices, including but not limited to a modem, router, server, set-top box, laptop, desktop, computer, tablet, mobile phone, etc.

Accordingly, a VQ importance index may be calculated which is indicative of the relative subjective importance of a portion (e.g. a macroblock) of a video image (e.g. frame). A higher VQ importance index value may be associated with more important regions. A lower VQ importance index may be associated with less important regions. The encoding quality may be improved utilizing the VQ importance index, because the quantization parameters may be adjusted based on the VQ importance index. As a result, the encoder may generate more bits encoding regions (e.g. macroblocks) with higher VQ importance index than regions (e.g. macroblocks) with lower VQ importance index.

Having described several embodiments, it will be recognized by those skilled in the art that various modifications, alternative constructions, and equivalents may be used without departing from the spirit of the disclosure. Additionally, a number of well-known processes and elements have not been described in order to avoid unnecessarily obscuring the embodiments disclosed herein. Accordingly, the above description should not be taken as limiting the scope of the document.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method of encoding comprising:
generating transform coefficients corresponding to macroblocks of video data, at least in part using a transform unit;
calculating a visual quality importance index for each of the macroblocks, wherein the visual quality importance index reflects a relative importance of the respective macroblock to subjective image quality;
receiving initial quantization parameters for the macroblocks from a rate control unit;
dynamically adjusting the quantization parameters based, at least in part, on the visual quality importance index; and
quantizing the transform coefficients using the dynamically adjusted quantization parameters.

2. The method of claim 1, wherein calculating the visual quality importance index comprises calculating content complexity of the macroblocks based, at least in part, on activity of the macroblocks.

3. The method of claim 2, wherein calculating the visual quality importance index comprises identifying information based, at least in part, on the content complexity of the macroblocks

4. The method of claim 1, wherein calculating the visual quality importance index comprises calculating a luminance contrast index for each of the macroblocks based, at least in part, on variance of activity of the macroblocks.

5. The method of claim 4, wherein calculating the visual quality importance index comprises identifying edge information based, at least in part, on the luminance of the macroblocks.

6. The method of claim 1, wherein calculating the visual quality importance index comprises calculating skintone color based, at least in part, on chroma components of the macroblocks.

7. The method of claim 1, wherein the quantization parameters received from the rate control unit are frame level quantization parameters.

8. The method of claim 1, wherein dynamically adjusting the quantization parameters comprises assigning a larger quantization parameter to a first macroblock of the macroblocks with a first visual quality importance index, wherein the larger quantization parameter is larger than a quantization parameter assigned to a second macroblock of the macroblocks having a second visual quality importance index, the first visual quality importance index being lower than the second visual quality importance index.

9. The method of claim 1, further comprising assigning more bits to the macroblocks with higher visual quality importance index than a threshold value and less bits to the macroblocks with lower visual quality index than the threshold value for encoding.

10. The method of claim 1, wherein the quantization parameters comprise a quantization step.

11. An encoding system comprising:
a transform unit configured to generate transform coefficients for macroblocks of video data;
a quantization unit coupled to the transform unit, wherein the quantization unit is configured to receive a visual quality importance index calculated for each of the macroblocks of video data based, at least in part on an activity in the respective macroblocks, and wherein the quantization unit is configured to receive initial quantization parameters and dynamically adjust the quantization parameters based, at least in part, on the calculated visual quality importance index; and
an encoder coupled to the quantization unit, wherein the encoder is configured to encode the macroblocks using the dynamically adjusted quantization parameters.

12. The encoder system of claim 11, wherein a processor is configured to calculate the visual quality importance index for each of the macroblocks of video data based, at least in part on the activity in the respective macroblocks.

13. The encoder system of claim 11, wherein the visual quality importance index is determined based, at least in part, on content complexity, luminance contrast index, edge information, and skintone color information of the macroblocks.

14. The encoder system of claim 13, wherein the content complexity for each of the macroblocks is based, at least in part, on the activity of the macroblocks.

15. The encoder system of claim 13, wherein the luminance contrast index for each of the macroblocks is based, at least in part, on variance of the activity of the macroblocks.

16. The encoder system of claim 13, wherein the edge information is based, at least in part, on the content complexity and luminance contrast index of the macroblocks.

17. The encoder system of claim 13, wherein the skintone color information is based, at least in part, on chroma components of the macroblocks.

18. The encoder system of claim 11, further comprising a rate control unit configured to provide the initial quantization parameters to the quantization unit.

19. The encoder system of claim 11, wherein the quantization unit is configured to assign a larger quantization parameter to a first macroblock of the macroblocks having a first visual quality importance index, wherein the larger quantization parameter is larger than a quantization parameter assigned to a second macroblock of the macroblocks having a second visual quality importance index, the first visual quality importance index being lower than the second visual quality importance index.

20. The encoder system of claim 11, wherein the encoder is configured to assign more bits to the macroblocks with higher visual quality importance index than a threshold value and less bits to the macroblocks with lower visual quality index than the threshold value.
